(19) United States
(12) Patent Application Publication
(10) Pub. No.: US 2025/0124392 A1
(43) Pub. Date: Apr. 17, 2025

(54) Travel Worker Mobile Application

(71) Applicant: Robin Gibbs Djibom, New Windsor, NY (US)

(72) Inventor: Robin Gibbs Djibom, New Windsor, NY (US)

(21) Appl. No.: 18/905,639

(22) Filed: Oct. 3, 2024

Related U.S. Application Data
(60) Provisional application No. 63/590,499, filed on Oct. 16, 2023.

(51) Int. Cl. G06Q 10/0639; G06Q 10/1053; G06Q 10/1091

(52) U.S. Cl. CPC G06Q 10/06398; G06Q 10/1053; G06Q 10/1091

(57) ABSTRACT

A travel worker mobile application is provided. The device is comprised of a mobile application that provides a comprehensive tool for managing work-related activities of traveling employees. More specifically, the application comprises multiple integrated features tailored to meet specific needs of traveling workers, including personalized profile creation, time tracking, performance monitoring, wage calculation, equipment usage tracking, and long-term record storage. Additional features include automated timesheet generation, job selection management, notifications and reminders, detailed reporting, expense tracking with reimbursement, and GPS integration for route optimization. These features collectively ensure accurate record-keeping, efficient task management, and optimized travel for users.

### CROSS-REFERENCE TO RELATED APPLICATION

The present application claims priority to, and the benefit of, U.S. Provisional Application No. 63/590,499, which was filed on Oct. 16, 2023, and is incorporated herein by reference in its entirety.

### FIELD OF THE INVENTION

The present invention relates generally to the field of mobile applications. More specifically, the present invention relates to a mobile application that travel workers can use to manage work-related factors, expenses, wages, etc. Accordingly, the present disclosure makes specific reference thereto. Nonetheless, it is to be appreciated that aspects of the present invention are also equally applicable to other like applications, devices, and methods of manufacture.

### BACKGROUND

Travel workers often face significant challenges when it comes to accurately recording their work hours and ensuring they are fairly compensated. Without the proper tools or systems in place, these workers may struggle to document their time spent on various job sites, making it difficult to provide evidence of their presence and the work they've completed. This lack of proper record-keeping can leave them vulnerable to disputes with employers who may claim that they never showed up to work or did not fulfill their job duties. Such disputes can lead to unjust accusations and potential loss of income, putting these workers in a precarious position.

Additionally, travel workers may be at risk of being underpaid, particularly concerning their wages and benefits. In many cases, these workers might not fully understand their entitlements, including the specific pay rates and benefits they should receive based on the nature of their work, the location of the job, and the type of equipment they use. This lack of awareness can result in them accepting lower pay than they are legally owed, either due to employer oversight or, in some cases, intentional underpayment.

Moreover, a significant issue is that many travel workers are not aware that they may be entitled to public work prevailing wages and benefits, which are often higher than standard rates. Prevailing wages are legally mandated pay rates for public work projects, designed to ensure that workers receive fair compensation that reflects the local standard of living and the specific demands of the job. When workers are unaware of these entitlements, they miss out on substantial financial benefits, including higher wages, health insurance, retirement contributions, and other important benefits that are crucial for their financial well-being.

This lack of knowledge and the absence of proper record-keeping mechanisms can lead to a cycle of under-compensation and exploitation, where travel workers consistently earn less than they deserve. Without intervention, these workers may continue to be shortchanged, with long-term impacts on their financial security, job satisfaction, and overall quality of life.

Therefore, there exists a long-felt need in the art for a tool that can be used by travel workers to ensure fair compensation. There also exists a long-felt need in the art for a travel worker mobile application. More specifically, there exists a long-felt need in the art for a travel worker mobile application that provides the ability for a travel worker to accurately keep records. Further, there exists a long-felt need in the art for a travel worker mobile application that ensures a travel worker is aware of pay rates, wages, and benefits they should receive.

The subject matter disclosed and claimed herein, in one embodiment thereof, comprises a travel worker mobile application. The device is comprised of a mobile application that provides a comprehensive tool for managing work-related activities of traveling employees. More specifically, the application comprises multiple integrated features tailored to meet the specific needs of traveling workers, including personalized profile creation, time tracking, performance monitoring, wage calculation, equipment usage tracking, and long-term record storage. Additional features include automated timesheet generation, job selection management, notifications and reminders, detailed reporting, expense tracking with reimbursement, and GPS integration for route optimization. These features collectively ensure accurate record-keeping, efficient task management, and optimized travel for users.

In this manner, the travel worker mobile application of the present invention accomplishes all the foregoing objectives and provides a tool that can be used by travel workers to ensure fair compensation. More specifically, the device provides the ability for a travel worker to accurately keep records. Further, the device ensures a travel worker is aware of pay rates, wages, and benefits they should receive.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a travel worker mobile application that may be in the form of software and/or a mobile application designed for smart devices that provides a comprehensive tool for managing various aspects of work-related activities for traveling employees.

Further, the application is comprised of a plurality of integrated features, each tailored to meet the specific needs of traveling employees. A first feature enables a user to create a personalized profile that allows the user to input a wide range of information. The profile feature may also include options to add certifications, skills, and any special qualifications that may influence wage and benefit calculations.

The application is also comprised of a time-tracking feature that enables traveling employees to track the time spent on various aspects of their work. This includes not only the time spent at the job site but also the time spent traveling between locations. Additionally, a performance monitoring feature provides users with the ability to actively monitor and record their job performance across multiple job sites. This feature may allow users to log daily tasks, track completion rates, and receive performance feedback, either from their own input or from employer evaluations.

A calculation feature delivers accurate wage and benefit information based on several key factors. Users can receive real-time calculations that take into account their job category, the geographic location of the job site (which may affect pay scales), and the specific equipment used during their tasks. This feature may also incorporate variables such as overtime, hazard pay, and other compensatory adjustments, providing a detailed and transparent overview of expected earnings.

An equipment usage tracking feature allows users to keep a detailed log of the various equipment utilized during their work. The application can factor in the frequency, duration, and type of equipment used to adjust wage calculations accordingly. For long-term data management, the application includes a record storage feature that allows users to securely store daily records of their activities, including detailed logs of travel time, hours worked, and tax deductions.

To further assist with administrative tasks, a timesheet and attendance generation feature automates the creation of timesheets based on the tracked hours and attendance records. A job selection feature offers users the ability to view and manage various job-related factors, including wages, benefits, and equipment usage, across both private and public sector jobs. Users can compare different job opportunities, evaluate potential earnings, and make informed decisions about accepting or declining job assignments.

Accordingly, the travel worker mobile application of the present invention is particularly advantageous as it provides a tool that can be used by travel workers to ensure fair compensation. More specifically, the device provides the ability for a travel worker to accurately keep records. Further, the device ensures a travel worker is aware of pay rates, wages, and benefits they should receive. In this manner, the travel worker mobile application can be used as a tool to address challenges commonly faced by travel workers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of features of one potential embodiment of a travel worker mobile application of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a tool that can be used by travel workers to ensure fair compensation. There also exists a long-felt need in the art for a travel worker mobile application. More specifically, there exists a long-felt need in the art for a travel worker mobile application that provides the ability for a travel worker to accurately keep records. Further, there exists a long-felt need in the art for a travel worker mobile application that ensures a travel worker is aware of pay rates, wages, and benefits they should receive.

The present invention, in one exemplary embodiment, is comprised of a travel worker mobile application. The application may be in the form of software and/or a mobile application designed for smart devices that provides a comprehensive tool for managing various aspects of work-related activities for traveling employees. Further, the application is comprised of a plurality of integrated features, each tailored to meet the specific needs of traveling employees. A first feature enables a user to create a personalized profile that allows the user to input a wide range of information. The profile feature may also include options to add certifications, skills, and any special qualifications that may influence wage and benefit calculations.

The application is also comprised of a time-tracking feature. This feature enables traveling employees to track the time spent on various aspects of their work. This includes not only the time spent at the job site but also the time spent traveling between locations. Additionally, a performance monitoring feature provides users with the ability to actively monitor and record their job performance across multiple job sites. This feature may allow users to log daily tasks, track completion rates, and receive performance feedback, either from their own input or from employer evaluations.

A calculation feature delivers accurate wage and benefit information based on several key factors. Users can receive real-time calculations that take into account their job category, the geographic location of the job site (which may affect pay scales), and the specific equipment used during their tasks. This feature may also incorporate variables such as overtime, hazard pay, and other compensatory adjustments, providing a detailed and transparent overview of expected earnings.

An equipment usage tracking feature allows users to keep a detailed log of the various equipment utilized during their work. The application can factor in the frequency, duration, and type of equipment used to adjust wage calculations accordingly. For long-term data management, the application includes a record storage feature that allows users to securely store daily records of their activities, including detailed logs of travel time, hours worked, and tax deductions.

To further assist with administrative tasks, a timesheet and attendance generation feature automates the creation of timesheets based on the tracked hours and attendance records. A job selection feature offers users the ability to view and manage various job-related factors, including wages, benefits, and equipment usage, across both private and public sector jobs. Users can compare different job opportunities, evaluate potential earnings, and make informed decisions about accepting or declining job assignments.

Accordingly, the travel worker mobile application of the present invention is particularly advantageous as it provides a tool that can be used by travel workers to ensure fair compensation. More specifically, the device provides the ability for a travel worker to accurately keep records. Further, the device ensures a travel worker is aware of pay rates, wages, and benefits they should receive. In this manner, the travel worker mobile application can be used as a tool to address challenges commonly faced by travel workers.

Further, the travel worker can submit a claim for “Wage and Benefits Under Payment” to the U.S. Department of Labor directly from the travel worker mobile application.

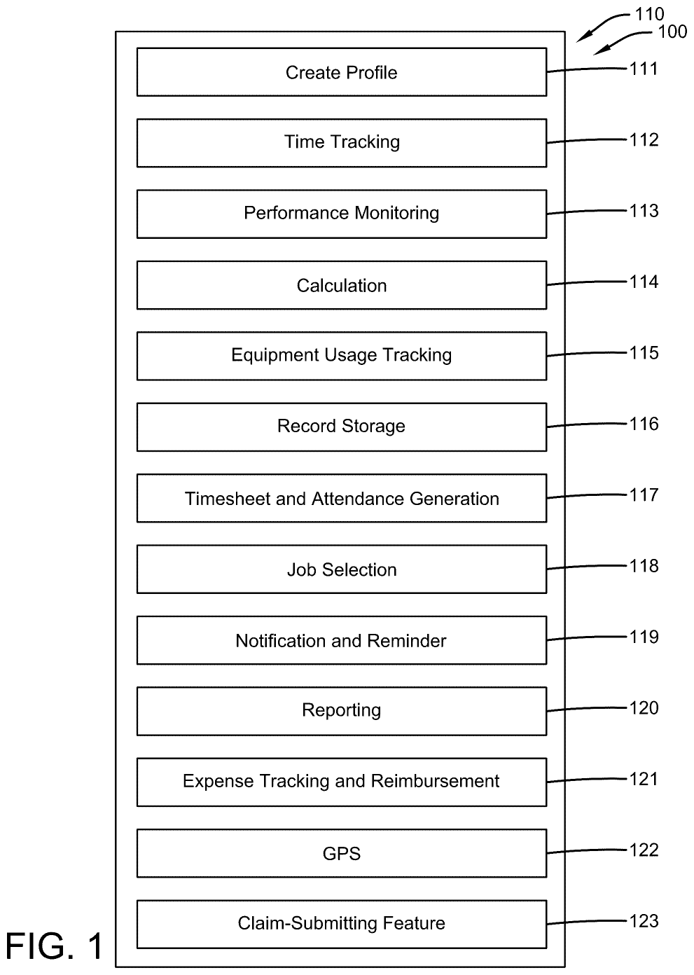

Referring initially to the drawings, FIG. 1 illustrates a graphical view of features of one potential embodiment of a travel worker mobile application 100 of the present invention in accordance with the disclosed architecture. The application 100 may be in the form of software and/or a mobile application designed for smart devices, such as cell phones or tablets. The application 100 provides a comprehensive tool for managing various aspects of work-related activities for traveling employees.

Further, the application 100 is comprised of a plurality of integrated features 110, each tailored to meet the specific needs of traveling employees. A first feature enables a user to create a personalized profile 111. This profile allows the user to input a wide range of information, including, but not limited to, personal details such as name, contact information, and employee ID, as well as professional information such as their employer's name, job title, job category, and specific responsibilities. The profile feature may also include options to add certifications, skills, and any special qualifications that may influence wage and benefit calculations.

The application 100 is also comprised of a time tracking feature 112 that enables traveling employees to track the time spent on various aspects of their work. This includes not only the time spent at the job site but also the time spent traveling between locations. The time tracking feature 112 may be configured to automatically log travel times based on GPS data or may allow manual input, offering flexibility depending on the user's preference. This feature ensures that all travel time is accurately recorded for proper compensation.

Additionally, a performance monitoring feature 113 provides users with the ability to actively monitor and record their job performance across multiple job sites. This feature may allow users to log daily tasks, track completion rates, and receive performance feedback, either from their own input or from employer evaluations. The performance data can be reviewed over time to assess progress, identify areas for improvement, and ensure that users maintain a high standard of work across different assignments.

A calculation feature 114 delivers accurate wage and benefit information based on several key factors. Users can receive real-time calculations that take into account their job category, the geographic location of the job site (which may affect pay scales), and the specific equipment used during their tasks. This feature may also incorporate variables such as overtime, hazard pay, and other compensatory adjustments, providing a detailed and transparent overview of expected earnings and also providing access to a prevailing wage schedule.

A claim-submitting feature 123 enables users to submit claims and/or complaints related to the underpayment of wages and benefits. This feature allows individuals who believe they have been wrongfully compensated or denied rightful benefits to initiate the claim process efficiently and securely through the application 100. In one embodiment, the claim can be submitted directly to the Department of Labor via the application 100, streamlining the process for users. The mobile application 100 may provide a guided, step-by-step interface that helps users input relevant information, such as wage records, employment history, and details about the alleged underpayment. In some implementations, the claim-submitting feature 123 can also facilitate tracking the status of the claim in real time, providing updates as the Department of Labor processes the submission. Furthermore, users may have the option to attach supporting documents or evidence, such as pay stubs or employment contracts, to strengthen their claim.

An equipment usage tracking feature 115 allows users to keep a detailed log of the various equipment utilized during their work. This is particularly useful for jobs where equipment usage impacts pay or job performance metrics. The application 100 can factor in the frequency, duration, and type of equipment used to adjust wage calculations accordingly. This feature may also help in tracking maintenance schedules and ensuring compliance with safety regulations related to equipment use.

For long-term data management, the application 100 includes a record storage feature 116. This feature allows users to securely store daily records of their activities, including detailed logs of travel time, hours worked, and tax deductions. These records can be easily accessed and reviewed, providing users with a historical archive of their work activity.

To further assist with administrative tasks, a timesheet and attendance generation feature 117 automates the creation of timesheets based on the tracked hours (wherein a user can clock in and out using the feature 117) and attendance records. This feature can generate comprehensive timesheets that detail daily, weekly, or monthly work activity, complete with summaries of payroll deductions. The generated timesheets can be exported in various formats such as, but not limited to, a PDF, an excel file, etc.

A job selection feature 118 offers users the ability to view and manage various job-related factors, including wages, benefits, and equipment usage, across both private and public sector jobs. Private sector jobs rates are calculated by a travel worker's base rate of pay. Users can compare different job opportunities, evaluate potential earnings, and make informed decisions about accepting or declining job assignments. This feature may also include options to filter jobs by criteria such as location, pay scale, or job category, further enhancing the user's ability to manage their employment effectively.

A notification and reminder feature 119 sends reminders for important tasks such as updating timesheets, tracking daily job performance, or logging equipment usage. This feature 119 could also notify users of upcoming deadlines, scheduled meetings, or travel arrangements, ensuring that all critical activities are completed on time.

A reporting feature 120 allows a user to generate detailed reports based on their tracked data. These reports could be tailored to show specific metrics such as travel expenses, overtime hours, equipment usage trends, or job performance over a certain period.

An expense tracking and reimbursement feature 121 tracks work-related expenses, such as travel costs, accommodation, and meals. Users could log their expenses, attach receipts, and submit them for reimbursement directly through the application 100.

Finally, a GPS feature 122 integrates with GPS to offer route optimization features. This would help users find the most efficient travel routes between job sites, reducing travel time and associated costs. The GPS data could also be used to automatically log travel times and distances.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “travel worker mobile application” and “application” are interchangeable and refer to the travel worker mobile application 100 of the present invention.

Notwithstanding the foregoing, the travel worker mobile application 100 of the present invention and its various components can be of any suitable size and configuration as is known in the art without affecting the overall concept of the invention, provided that they accomplish the above-stated objectives. One of ordinary skill in the art will appreciate that the size, configuration, and material of the travel worker mobile application 100 as shown in the FIGS. are for illustrative purposes only, and that many other sizes and shapes of the travel worker mobile application 100 are well within the scope of the present disclosure. Although the dimensions of the travel worker mobile application 100 are important design parameters for user convenience, the travel worker mobile application 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A travel worker mobile application comprising:
a mobile application comprised of:
a profile feature;
a time-tracking feature;
a performance monitoring feature;
a calculation feature;
an equipment usage feature;
a record storage feature;
a timesheet and attendance generation feature; and
a job selection feature.

2. The travel worker mobile application of claim 1, wherein the profile features allow a user to input a name, a contact information, an employee ID, an employer's name, a job title, a job category, a responsibility, a certification, a skill, or a qualification.

3. The travel worker mobile application of claim 1, wherein the time tracking automatically logs a travel time based on a GPS data or a manual input.

4. The travel worker mobile application of claim 1, wherein the performance monitoring feature allows a user to log a daily task, track a completion rate, receive a performance feedback, and review a performance data.

5. The travel worker mobile application of claim 1, wherein the calculation feature calculates an expected wage and an expected benefit.

6. The travel worker mobile application of claim 1, wherein the equipment usage feature allows a user to log a piece of equipment used.

7. The travel worker mobile application of claim 1, wherein the equipment usage feature logs a frequency, a duration, and a type of equipment used.

8. The travel worker mobile application of claim 1, wherein the record storage features allows a user to store a daily record, the daily record comprised of a travel log, an amount of hours worked, and a tax deduction.

9. The travel worker mobile application of claim 5, wherein the calculation features calculates the expected wage and the expected benefit while factoring in an overtime pay and a hazard pay.

10. The travel worker mobile application of claim 1, wherein the timesheet and attendance generation feature creates a timesheet based on an amount of hours worked and an attendance record.

11. The travel worker mobile application of claim 1, wherein the job selection feature allows a user to view a wage, a benefit, and an equipment usage related to a private sector job or a public sector job.

12. A travel worker mobile application comprising:
a computer software comprised of:
a profile feature;
a time-tracking feature;
a performance monitoring feature;
a calculation feature;
an equipment usage feature;
a record storage feature;
a timesheet and attendance generation feature;
a job selection feature;
a notification and reminder feature; and
a reporting feature.

13. The travel worker mobile application of claim 12, wherein the notification and reminder feature sends a reminder.

14. The travel worker mobile application of claim 12, wherein the reporting features generate a report based on a set of data tracked by the travel worker mobile application.

15. A travel worker mobile application comprising:
an application comprised of:
a profile feature;
a time-tracking feature;
a performance monitoring feature;
a calculation feature;
an equipment usage feature;
a record storage feature;
a timesheet and attendance generation feature;
a job selection feature;
a notification and reminder feature;
a reporting feature;
an expense tracking and reimbursement feature; and
a GPS feature.

16. The travel worker mobile application of claim 15, wherein the expense tracking and reimbursement feature tracks a travel cost, an accommodation, or a meal.

17. The travel worker mobile application of claim 15, wherein the GPS feature automatically logs a travel time and a travel distance.

18. The travel worker mobile application of claim 15, wherein the expense tracking and reimbursement feature allows a user to log an expense or attach a receipt and submit the expense or the receipt for reimbursement using the travel work mobile application.

19. The travel worker mobile application of claim 15, wherein the calculation feature calculates an expected wage and an expected benefit.

20. The travel worker mobile application of claim 15, wherein the equipment usage feature allows a user to log a piece of equipment used.
